(19) United States
(12) Patent Application Publication
(10) Pub. No.: US 2020/0230820 A1
(43) Pub. Date: Jul. 23, 2020

(54) INFORMATION PROCESSING APPARATUS, SELF-LOCALIZATION METHOD, PROGRAM, AND MOBILE BODY

(71) Applicant: SONY CORPORATION, TOKYO (JP)

(72) Inventors: RYO WATANABE, TOKYO (JP); DAI KOBAYASHI, TOKYO (JP); MASATAKA TOYOURA, TOKYO (JP)

(21) Appl. No.: 16/652,825

(22) PCT Filed: Sep. 26, 2018
(86) PCT No.: PCT/JP2018/035556

§ 371 Date: Apr. 1, 2020

(30) Foreign Application Priority Data
Oct. 10, 2017 (JP) 2017-196947

(51) Int. Cl. B25J 9/16; G06T 7/00; G06T 7/285

(52) U.S. Cl. CPC B25J 9/1697; G06T 7/285; G06T 7/001; B25J 9/1664

(57) ABSTRACT

The present technology relates to an information processing apparatus, a self-localization method, a program, and a mobile body that allow for improvement in the accuracy of self-localization of the mobile body. The information processing apparatus includes: a comparison unit that compares a plurality of captured images with a reference image imaged in advance, the plurality of captured images being images obtained by imaging a predetermined direction at different positions; and a self-localization unit that performs self-localization of a mobile body on the basis of a result of the comparison between each of the plurality of captured images and the reference image. The present technology can be applied to a system that performs self-localization of a mobile body, for example.

### TECHNICAL FIELD

The present technology relates to an information processing apparatus, a self-localization method, a program, and a mobile body, and more particularly to an information processing apparatus, a self-localization method, a program, and a mobile body that allow for improvement in the accuracy of self-localization of the mobile body.

### BACKGROUND ART

Conventionally, it has been proposed that a robot including a stereo camera and a laser range finder performs self-localization of the robot on the basis of an image captured by the stereo camera and range data obtained by the laser range finder (see, for example, Patent Document 1).

It has also been proposed to perform local feature matching between sequential images that are captured sequentially while a robot moves, calculate an average of matched local feature values as an invariant feature, and generate a local metrical map having each invariant feature and distance information for use in self-localization of the robot (see, for example, Patent Document 2).

### CITATION LIST

### Patent Document

Patent Document 1: Japanese Patent Application Laid-Open No. 2007-322138
Patent Document 2: Japanese Patent Application Laid-Open No. 2012-64131

### SUMMARY OF THE INVENTION

### Problems to be Solved by the Invention

As indicated in Patent Document 1 and Patent Document 2, it is desired to improve the accuracy of self-localization of a mobile body.

The present technology has been made in view of such a situation, and is intended to improve the accuracy of self-localization of a mobile body.

### Solutions to Problems

An information processing apparatus according to a first aspect of the present technology includes: a comparison unit that compares a plurality of captured images with a reference image imaged in advance, the plurality of captured images being images obtained by imaging a predetermined direction at different positions; and a self-localization unit that performs self-localization of a mobile body on the basis of a result of the comparison between each of the plurality of captured images and the reference image.

In an information processing method according to the first aspect of the present technology, the information processing apparatus performs comparison between a plurality of captured images and a reference image imaged in advance, and performs self-localization of a mobile body on the basis of a result of the comparison between each of the plurality of captured images and the reference image, the plurality of captured images being images obtained by imaging a predetermined direction at different positions.

A program according to the first aspect of the present technology causes a computer to execute processing of comparison between a plurality of captured images and a reference image imaged in advance, and self-localization of a mobile body on the basis of a result of the comparison between each of the plurality of captured images and the reference image, the plurality of captured images being images obtained by imaging a predetermined direction at different positions.

A mobile body according to a second aspect of the present technology includes: a comparison unit that compares a plurality of captured images with a reference image captured in advance, the plurality of captured images being images obtained by imaging a predetermined direction at different positions; and a self-localization unit that performs self-localization on the basis of a result of the comparison between each of the plurality of captured images and the reference image.

In the first aspect of the present technology, the plurality of captured images, which is the images obtained by imaging the predetermined direction at the different positions, is compared with the reference image imaged in advance, and self-localization of the mobile body is performed on the basis of the result of the comparison between each of the plurality of captured images and the reference image.

In the second aspect of the present technology, the plurality of captured images, which is the images obtained by imaging the predetermined direction at the different positions, is compared with the reference image imaged in advance, and self-localization is performed on the basis of the result of the comparison between each of the plurality of captured images and the reference image.

### Effects of the Invention

According to the first aspect or the second aspect of the present technology, the accuracy of self-localization of the mobile body can be improved.

Note that the present technology has an effect not necessarily limited to the one described herein, but may have any effect described in the present disclosure.

### BRIEF DESCRIPTION OF DRAWINGS

FIG. 1 is a block diagram illustrating an example of the configuration of general functions of a vehicle control system to which the present technology can be applied.

FIG. 2 is a block diagram illustrating an embodiment of a self-localization system to which the present technology is applied.

FIG. 3 is a flowchart for explaining key frame generation processing.

FIG. 4 is a flowchart for explaining self-localization processing.

FIG. 5 is a flowchart for explaining the self-localization processing.

FIG. 6 is a diagram illustrating a position of a vehicle.

FIG. 7 is a diagram illustrating an example of a front image.

FIG. 8 is a graph illustrating an example of a matching rate prediction function.

FIG. 9 is a diagram for explaining an example in a case where a lane change is made.

FIG. 10 is a graph for explaining an amount of error of a matching rate.

FIG. 11 is a graph for explaining a method of finalizing a result of estimation of the position and orientation of a vehicle.

FIG. 12 is a diagram illustrating an example of the configuration of a computer.

### MODES FOR CARRYING OUT THE INVENTION

Modes for carrying out the present technology will be described below. The description will be made in the following order.

1. Example of configuration of vehicle control system

2. Embodiment

3. Variation

4. Other

### 1. Example of Configuration of Vehicle Control System

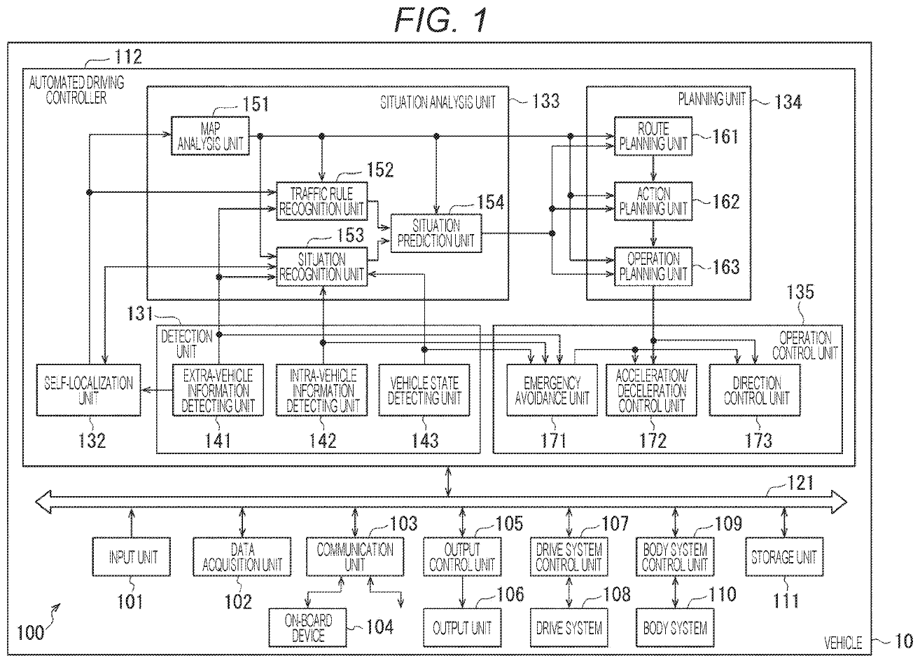

FIG. 1 is a block diagram illustrating an example of the configuration of general functions of a vehicle control system 100 that is an example of a mobile body control system to which the present technology can be applied.

The vehicle control system 100 is a system that is provided in a vehicle 10 and performs various controls of the vehicle 10. Note that the vehicle 10 will be hereinafter referred to as a vehicle of the system in a case where the vehicle 10 is to be distinguished from another vehicle.

The vehicle control system 100 includes an input unit 101, a data acquisition unit 102, a communication unit 103, an on-board device 104, an output control unit 105, an output unit 106, a drive system control unit 107, a drive system 108, a body system control unit 109, a body system 110, a storage unit 111, and an automated driving controller 112. The input unit 101, the data acquisition unit 102, the communication unit 103, the output control unit 105, the drive system control unit 107, the body system control unit 109, the storage unit 111, and the automated driving controller 112 are connected to one another via a communication network 121. The communication network 121 includes an in-vehicle communication network, a bus, or the like in conformance with an arbitrary standard such as a Controller Area Network (CAN), a Local Interconnect Network (LIN), a Local Area Network (LAN), or FlexRay (registered trademark), for example. Note that the units of the vehicle control system 100 are connected directly without the communication network 121 in some cases.

Note that in the following, the communication network 121 will not be mentioned in a case where the units of the vehicle control system 100 perform communication via the communication network 121. For example, in a case where the input unit 101 and the automated driving controller 112 perform communication via the communication network 121, it will simply be described that the input unit 101 and the automated driving controller 112 perform communication.

The input unit 101 includes a device used by an occupant to input various data, instructions, and the like. For example, the input unit 101 includes an operation device such as a touch panel, a button, a microphone, a switch, or a lever, an operation device that enables input by a method other than manual operation such as by voice or a gesture, or the like. Alternatively, for example, the input unit 101 may be a remote control device using infrared rays or other radio waves, or an external connected device such as a mobile device or a wearable device supporting the operation of the vehicle control system 100. The input unit 101 generates an input signal on the basis of data, an instruction, or the like input by an occupant and supplies the input signal to each unit of the vehicle control system 100.

The data acquisition unit 102 includes various sensors and the like that acquire data used for processing of the vehicle control system 100, and supplies the acquired data to each unit of the vehicle control system 100.

For example, the data acquisition unit 102 includes various sensors that detect a state of the vehicle 10 and the like. Specifically, for example, the data acquisition unit 102 includes a gyro sensor, an acceleration sensor, an inertial measurement unit (IMU), and a sensor that detects an amount of operation on a gas pedal, an amount of operation on a brake pedal, a steering angle of a steering wheel, an engine speed, a motor speed, a rotational speed of wheels, or the like.

Moreover, for example, the data acquisition unit 102 includes various sensors that detect information outside the vehicle 10. Specifically, for example, the data acquisition unit 102 includes an imaging apparatus such as a Time of Flight (ToF) camera, a stereo camera, a monocular camera, an infrared camera, or other cameras. Furthermore, for example, the data acquisition unit 102 includes an environment sensor that detects climate or weather and the like, and a surrounding information sensor that detects an object around the vehicle 10. The environment sensor includes, for example, a raindrop sensor, a fog sensor, a solar radiation sensor, a snow sensor, or the like. The surrounding information sensor includes, for example, an ultrasonic sensor, a radar, Light Detection and Ranging, Laser Imaging Detection and Ranging (LiDAR), a sonar, or the like.

Moreover, for example, the data acquisition unit 102 includes various sensors that detect a current position of the vehicle 10. Specifically, for example, the data acquisition unit 102 includes a Global Navigation Satellite System (GNSS) receiver or the like, the GNSS receiver receiving a satellite signal (hereinafter referred to as a GNSS signal) from a GNSS satellite that is a navigation satellite.

Moreover, for example, the data acquisition unit 102 includes various sensors that detect information inside a vehicle. Specifically, for example, the data acquisition unit 102 includes an imaging apparatus that images a driver, a biosensor that detects biometric information of a driver, a microphone that collects sound inside a vehicle, or the like. The biosensor is provided on, for example, a seat surface, a steering wheel, or the like and detects biometric information of an occupant sitting in the seat or a driver holding the steering wheel.

The communication unit 103 communicates with the on-board device 104 and various devices, a server, a base station, and the like outside the vehicle, thereby transmitting data supplied from each unit of the vehicle control system 100 and supplying received data to each unit of the vehicle control system 100. Note that the communication protocol supported by the communication unit 103 is not particularly limited, and the communication unit 103 can support a plurality of types of communication protocols as well.

For example, the communication unit 103 performs wireless communication with the on-board device 104 by a wireless LAN, Bluetooth (registered trademark), Near Field Communication (NFC), wireless USB (WUSB), or the like. Also, for example, the communication unit 103 performs wired communication with the on-board device 104 by a Universal Serial Bus (USB), High-Definition Multimedia Interface (HDMI (registered trademark)), Mobile High-definition Link (MHL), or the like via a connection terminal (and a cable if necessary) not shown.

Furthermore, for example, the communication unit 103 communicates with a device (for example, an application server or a control server) existing on an external network (for example, the Internet, a cloud network, or an operator-specific network) via a base station or an access point. Also, for example, the communication unit 103 uses a Peer To Peer (P2P) technology to communicate with a terminal (for example, a terminal held by a pedestrian or placed in a store, or a Machine Type Communication (MTC) terminal) that is in the vicinity of the vehicle 10. Also, for example, the communication unit 103 performs V2X communication such as vehicle-to-vehicle communication, vehicle-to-infrastructure communication, communication between the vehicle 10 and a home (vehicle-to-home communication), and vehicle-to-pedestrian communication. Moreover, for example, the communication unit 103 includes a beacon receiver to receive radio waves or electromagnetic waves transmitted from a wireless station or the like installed on a road, and acquire information on a current position, traffic jam, traffic regulation, required time, or the like.

The on-board device 104 includes, for example, a mobile device or wearable device that is possessed by an occupant, an information device that is carried into or attached in the vehicle 10, a navigation device that searches for a route to an arbitrary destination, or the like.

The output control unit 105 controls the output of various information to an occupant of the vehicle 10 or the outside of the vehicle. For example, the output control unit 105 generates an output signal including at least one of visual information (for example, image data) or auditory information (for example, audio data), supplies the output signal to the output unit 106, and controls the output of the visual information and/or auditory information from the output unit 106. Specifically, for example, the output control unit 105 generates a bird's eye image, a panoramic image, or the like by combining image data imaged by different imaging apparatuses of the data acquisition unit 102, and supplies an output signal including the generated image to the output unit 106. Moreover, for example, the output control unit 105 generates audio data including a warning sound, a warning message, or the like for danger such as a collision, contact, or entry into a dangerous zone, and supplies an output signal including the generated audio data to the output unit 106.

The output unit 106 includes a device capable of outputting visual information or auditory information to an occupant of the vehicle 10 or the outside of the vehicle. For example, the output unit 106 includes a display device, an instrument panel, an audio speaker, headphones, a wearable device such as a glasses-type display worn by an occupant, a projector, a lamp, or the like. The display device included in the output unit 106 may be a device having a normal display or also be, for example, a device that displays visual information within a driver's field of view such as a head-up display, a transmissive display, or a device having an Augmented Reality (AR) display function.

The drive system control unit 107 controls the drive system 108 by generating various control signals and supplying them to the drive system 108. The drive system control unit 107 also supplies a control signal to each unit other than the drive system 108 as necessary, and provides notification of a control state of the drive system 108 and the like.

The drive system 108 includes various devices related to the drive system of the vehicle 10. For example, the drive system 108 includes a driving power generator that generates driving power such as an internal combustion engine or a driving motor, a driving power transmission mechanism that transmits the driving power to wheels, a steering mechanism that adjusts a steering angle, a braking device that generates a braking force, an Antilock Brake System (ABS), an Electronic Stability Control (ESC), an electric power steering device, and the like.

The body system control unit 109 controls the body system 110 by generating various control signals and supplying them to the body system 110. The body system control unit 109 also supplies a control signal to each unit other than the body system 110 as necessary, and provides notification of a control state of the body system 110 and the like.

The body system 110 includes various devices of the body system that are mounted to a vehicle body. For example, the body system 110 includes a keyless entry system, a smart key system, a power window device, a power seat, a steering wheel, an air conditioner, various lamps (for example, a head lamp, a back lamp, a brake lamp, a turn signal, a fog lamp, and the like), and the like.

The storage unit 111 includes, for example, a Read Only Memory (ROM), a Random Access Memory (RAM), a magnetic storage device such as a Hard Disc Drive (HDD), a semiconductor storage device, an optical storage device, a magneto-optical storage device, and the like. The storage unit 111 stores various programs, data, and the like used by each unit of the vehicle control system 100. For example, the storage unit 111 stores map data including a three-dimensional high-precision map such as a dynamic map, a global map having lower precision than the high-precision map but covering a wide area, a local map containing information around the vehicle 10, and the like.

The automated driving controller 112 performs control related to automated driving such as autonomous driving or driving assistance. Specifically, for example, the automated driving controller 112 performs cooperative control for the purpose of implementing the functions of an Advanced Driver Assistance System (ADAS) including collision avoidance or impact mitigation for the vehicle 10, travel following a vehicle ahead, constant speed travel, or a collision warning for the vehicle 10 based on the distance between vehicles, a warning for the vehicle 10 going off the lane, and the like. Also, for example, the automated driving controller 112 performs cooperative control for the purpose of automated driving or the like that enables autonomous driving without depending on a driver's operation. The automated driving controller 112 includes a detection unit 131, a self-localization unit 132, a situation analysis unit 133, a planning unit 134, and an operation control unit 135.

The detection unit 131 detects various information necessary for controlling automated driving. The detection unit 131 includes an extra-vehicle information detecting unit 141, an intra-vehicle information detecting unit 142, and a vehicle state detecting unit 143.

The extra-vehicle information detecting unit 141 performs processing of detecting information outside the vehicle 10 on the basis of data or a signal from each unit of the vehicle control system 100. For example, the extra-vehicle information detecting unit 141 performs processings of detecting, recognizing, and tracking an object around the vehicle 10, and processing of detecting the distance to the object. The object to be detected includes, for example, a vehicle, a person, an obstacle, a structure, a road, a traffic light, a traffic sign, a road marking, or the like. Also, for example, the extra-vehicle information detecting unit 141 performs processing of detecting an ambient environment of the vehicle 10. The ambient environment to be detected includes, for example, weather, temperature, humidity, brightness, road surface condition, or the like. The extra-vehicle information detecting unit 141 supplies data indicating a result of the detection processing to the self-localization unit 132, a map analysis unit 151, a traffic rule recognition unit 152, and a situation recognition unit 153 of the situation analysis unit 133, an emergency avoidance unit 171 of the operation control unit 135, and the like.

The intra-vehicle information detecting unit 142 performs processing of detecting information inside the vehicle on the basis of data or a signal from each unit of the vehicle control system 100. For example, the intra-vehicle information detecting unit 142 performs processings of authenticating and recognizing a driver, processing of detecting a state of the driver, processing of detecting an occupant, processing of detecting an environment inside the vehicle, or the like. The state of the driver to be detected includes, for example, a physical condition, a level of being awake, a level of concentration, a level of fatigue, a line-of-sight direction, or the like. The environment inside the vehicle to be detected includes, for example, temperature, humidity, brightness, smell, or the like. The intra-vehicle information detecting unit 142 supplies data indicating a result of the detection processing to the situation recognition unit 153 of the situation analysis unit 133, the emergency avoidance unit 171 of the operation control unit 135, and the like.

The vehicle state detecting unit 143 performs processing of detecting a state of the vehicle 10 on the basis of data or a signal from each unit of the vehicle control system 100. The state of the vehicle 10 to be detected includes, for example, speed, acceleration, a steering angle, presence/absence and details of abnormality, a state of driving operation, power seat position and inclination, a state of door lock, a state of another on-board device, or the like. The vehicle state detecting unit 143 supplies data indicating a result of the detection processing to the situation recognition unit 153 of the situation analysis unit 133, the emergency avoidance unit 171 of the operation control unit 135, and the like.

The self-localization unit 132 performs processing of estimating a position, an orientation, and the like of the vehicle 10 on the basis of data or a signal from each unit of the vehicle control system 100 such as the extra-vehicle information detecting unit 141 and the situation recognition unit 153 of the situation analysis unit 133. The self-localization unit 132 also generates a local map (hereinafter referred to as a self-localization map) used for self-localization as necessary. The self-localization map is, for example, a high-precision map using a technique such as Simultaneous Localization and Mapping (SLAM). The self-localization unit 132 supplies data indicating a result of the estimation processing to the map analysis unit 151, the traffic rule recognition unit 152, and the situation recognition unit 153 of the situation analysis unit 133, and the like. The self-localization unit 132 also causes the storage unit 111 to store the self-localization map.

The situation analysis unit 133 performs processing of analyzing a situation of the vehicle 10 and the surroundings. The situation analysis unit 133 includes the map analysis unit 151, the traffic rule recognition unit 152, the situation recognition unit 153, and a situation prediction unit 154.

The map analysis unit 151 performs processing of analyzing various maps stored in the storage unit 111 while using, as necessary, data or a signal from each unit of the vehicle control system 100 such as the self-localization unit 132 and the extra-vehicle information detecting unit 141, and constructs a map that contains information necessary for automated driving processing. The map analysis unit 151 supplies the constructed map to the traffic rule recognition unit 152, the situation recognition unit 153, the situation prediction unit 154, a route planning unit 161, an action planning unit 162, and an operation planning unit 163 of the planning unit 134, and the like.

The traffic rule recognition unit 152 performs processing of recognizing a traffic rule in the vicinity of the vehicle 10 on the basis of data or a signal from each unit of the vehicle control system 100 such as the self-localization unit 132, the extra-vehicle information detecting unit 141, the map analysis unit 151, and the like. This recognition processing allows for the recognition of, for example, a position and a state of a traffic light in the vicinity of the vehicle 10, details of traffic regulations in the vicinity of the vehicle 10, a lane in which the vehicle can travel, or the like. The traffic rule recognition unit 152 supplies data indicating a result of the recognition processing to the situation prediction unit 154 and the like.

The situation recognition unit 153 performs processing of recognizing a situation related to the vehicle 10 on the basis of data or a signal from each unit of the vehicle control system 100 such as the self-localization unit 132, the extra-vehicle information detecting unit 141, the intra-vehicle information detecting unit 142, the vehicle state detecting unit 143, and the map analysis unit 151. For example, the situation recognition unit 153 performs processing of recognizing a situation of the vehicle 10, a situation around the vehicle 10, a situation of the driver of the vehicle 10, or the like. The situation recognition unit 153 also generates a local map (hereinafter referred to as a situation recognition map) used for the recognition of the situation around the vehicle 10 as necessary. The situation recognition map is, for example, an occupancy grid map.

The situation of the vehicle 10 to be recognized includes, for example, the position, orientation, and movement (for example, the speed, acceleration, direction of travel, or the like) of the vehicle 10, the presence/absence and details of abnormality, or the like. The situation around the vehicle 10 to be recognized includes, for example, the type and position of a surrounding stationary object, the type, position, and movement (for example, the speed, acceleration, direction of travel, or the like) of a surrounding mobile object, the configuration and surface conditions of a surrounding road, and ambient weather, temperature, humidity, brightness, and the like. The state of the driver to be recognized includes, for example, a physical condition, a level of being awake, a level of concentration, a level of fatigue, a line-of-sight movement, a driving operation, or the like.

The situation recognition unit 153 supplies data (including the situation recognition map as necessary) indicating a result of the recognition processing to the self-localization unit 132, the situation prediction unit 154, and the like. The situation recognition unit 153 also causes the storage unit 111 to store the situation recognition map.

The situation prediction unit 154 performs processing of predicting a situation related to the vehicle 10 on the basis of data or a signal from each unit of the vehicle control system 100 such as the map analysis unit 151, the traffic rule recognition unit 152, and the situation recognition unit 153. For example, the situation prediction unit 154 performs processing of predicting a situation of the vehicle 10, a situation around the vehicle 10, a situation of the driver, or the like.

The situation of the vehicle 10 to be predicted includes, for example, a behavior of the vehicle 10, occurrence of abnormality, a distance the vehicle can travel, or the like. The situation around the vehicle 10 to be predicted includes, for example, a behavior of a mobile object around the vehicle 10, a change in state of a traffic light, a change in the environment such as weather, or the like. The situation of the driver to be predicted includes, for example, a behavior, a physical condition, or the like of the driver.

The situation prediction unit 154 supplies data indicating a result of the prediction processing to the route planning unit 161, the action planning unit 162, and the operation planning unit 163 of the planning unit 134 and the like together with the data from the traffic rule recognition unit 152 and the situation recognition unit 153.

The route planning unit 161 plans a route to a destination on the basis of data or a signal from each unit of the vehicle control system 100 such as the map analysis unit 151 and the situation prediction unit 154. For example, the route planning unit 161 sets a route from a current position to a designated destination on the basis of the global map. Also, for example, the route planning unit 161 changes the route as appropriate on the basis of a situation such as a traffic jam, an accident, traffic regulations, or construction, a physical condition of the driver, or the like. The route planning unit 161 supplies data indicating the planned route to the action planning unit 162 and the like.

The action planning unit 162 plans an action of the vehicle 10 in order for the vehicle to travel the route planned by the route planning unit 161 safely within the planned time, on the basis of data or a signal from each unit of the vehicle control system 100 such as the map analysis unit 151 and the situation prediction unit 154. For example, the action planning unit 162 performs planning for start, stop, a direction of travel (for example, a forward movement, backward movement, left turn, right turn, change of direction, or the like), a driving lane, a driving speed, passing, or the like. The action planning unit 162 supplies data indicating the planned action of the vehicle 10 to the operation planning unit 163 and the like.

The operation planning unit 163 plans an operation of the vehicle 10 to achieve the action planned by the action planning unit 162, on the basis of data or a signal from each unit of the vehicle control system 100 such as the map analysis unit 151 and the situation prediction unit 154. For example, the operation planning unit 163 performs planning for acceleration, deceleration, a path of travel, or the like. The operation planning unit 163 supplies data indicating the planned operation of the vehicle 10 to an acceleration/deceleration control unit 172 and a direction control unit 173 of the operation control unit 135 and the like.

The operation control unit 135 controls the operation of the vehicle 10. The operation control unit 135 includes the emergency avoidance unit 171, the acceleration/deceleration control unit 172, and the direction control unit 173.

The emergency avoidance unit 171 performs processing of detecting an emergency such as a collision, contact, entry into a dangerous zone, abnormality of the driver, or abnormality of the vehicle 10 on the basis of results of detection by the extra-vehicle information detecting unit 141, the intra-vehicle information detecting unit 142, and the vehicle state detecting unit 143. In a case where the emergency avoidance unit 171 has detected the occurrence of an emergency, the emergency avoidance unit 171 plans an operation of the vehicle 10 for avoiding the emergency such as a sudden stop or steep turn. The emergency avoidance unit 171 supplies data indicating the planned operation of the vehicle 10 to the acceleration/deceleration control unit 172, the direction control unit 173, and the like.

The acceleration/deceleration control unit 172 performs acceleration/deceleration control for achieving the operation of the vehicle 10 planned by the operation planning unit 163 or the emergency avoidance unit 171. For example, the acceleration/deceleration control unit 172 calculates a control target value for the driving power generator or braking device to achieve the planned acceleration, deceleration, or sudden stop, and supplies a control command indicating the calculated control target value to the drive system control unit 107.

The direction control unit 173 performs direction control for achieving the operation of the vehicle 10 planned by the operation planning unit 163 or the emergency avoidance unit 171. For example, the direction control unit 173 calculates a control target value for the steering mechanism to achieve the path of travel or steep turn planned by the operation planning unit 163 or the emergency avoidance unit 171, and supplies a control command indicating the calculated control target value to the drive system control unit 107.

### 2. Embodiment

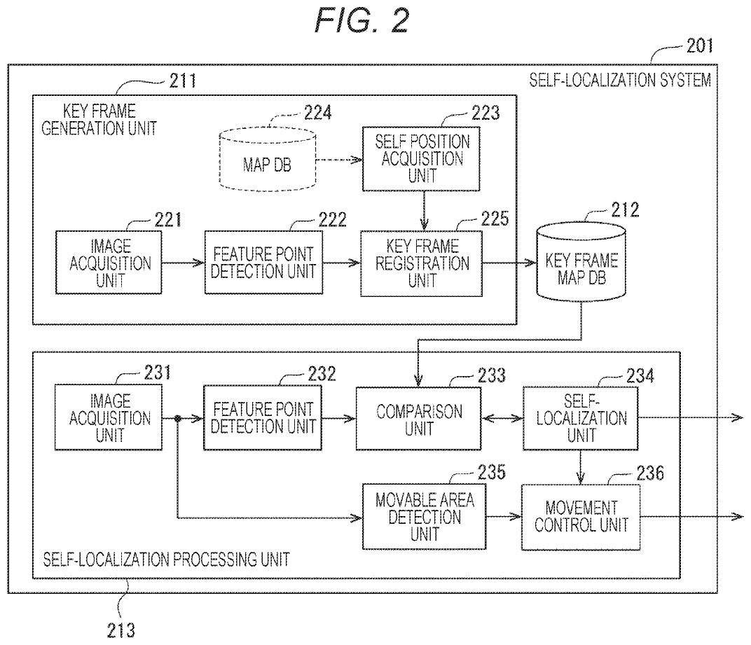

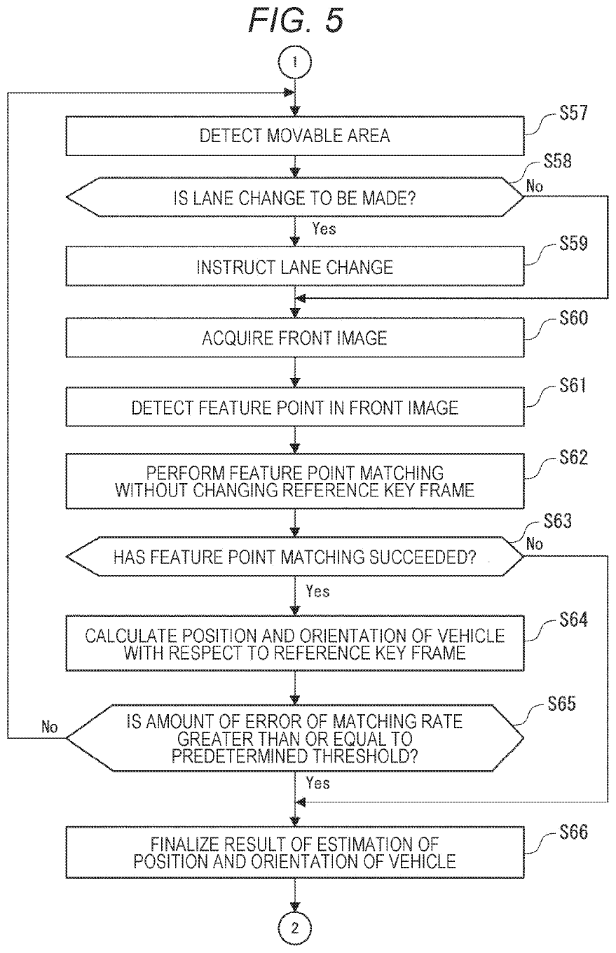

Next, an embodiment of the present technology will be described with reference to FIGS. 2 to 11.

Note that the present embodiment describes a technology associated with the processings of mainly the self-localization unit 132, the extra-vehicle information detecting unit 141, the situation recognition unit 153, and the action planning unit 162 of the vehicle control system 100 in FIG. 1 and the processing of generating map data used for self-localization processing.

<Example of Configuration of Self-Localization System>

FIG. 2 is a block diagram illustrating an example of the configuration of a self-localization system 201 that is an embodiment of a self-localization system to which the present technology is applied.

The self-localization system 201 is a system that performs self-localization of the vehicle 10 and estimates the position and orientation of the vehicle 10.

The self-localization system 201 includes a key frame generation unit 211, a key frame map database (DB) 212, and a self-localization processing unit 213.

The key frame generation unit 211 performs processing of generating a key frame that configures a key frame map.

Note that the key frame generation unit 211 need not necessarily be provided in the vehicle 10. For example, the key frame generation unit 211 may be provided in a vehicle different from the vehicle 10, and a key frame may be generated using the different vehicle.

Note that the following describes an example of the case where the key frame generation unit 211 is provided in a vehicle (hereinafter referred to as a map generating vehicle) different from the vehicle 10.

The key frame generation unit 211 includes an image acquisition unit 221, a feature point detection unit 222, a self position acquisition unit 223, a map database (DB) 224, and a key frame registration unit 225. Note that the map DB 224 is not necessarily required, and is provided in the key frame generation unit 211 as necessary.

The image acquisition unit 221 includes a camera, for example, to image an area in front of the map generating vehicle and supply the captured image obtained (hereinafter referred to as a reference image) to the feature point detection unit 222.

The feature point detection unit 222 performs processing of detecting a feature point in the reference image, and supplies data indicating a result of the detection to the key frame registration unit 225.

The self position acquisition unit 223 acquires data indicating the position and orientation of the map generating vehicle in a map coordinate system (geographic coordinate system), and supplies the data to the key frame registration unit 225.

Note that an arbitrary method can be used as a method of acquiring the data indicating the position and orientation of the map generating vehicle. For example, the data indicating the position and orientation of the map generating vehicle is acquired on the basis of at least one or more of a Global Navigation Satellite System (GNSS) signal that is a satellite signal from a navigation satellite, a geomagnetic sensor, wheel odometry, or Simultaneous Localization and Mapping (SLAM). Also, map data stored in the map DB 224 is used as necessary.

The map DB 224 is provided as necessary and stores the map data used in the case where the self position acquisition unit 223 acquires the data indicating the position and orientation of the map generating vehicle.

The key frame registration unit 225 generates a key frame and registers the key frame in the key frame map DB 212. The key frame includes data indicating, for example, the position and feature value of each feature point detected in the reference image in an image coordinate system, and the position and orientation of the map generating vehicle in the map coordinate system when the reference image is imaged (that is, the position and orientation at which the reference image is imaged).

Note that hereinafter, the position and orientation of the map generating vehicle when the reference image used for generating the key frame is imaged will also be simply referred to as the position and orientation at which the key frame is acquired.

The key frame map DB 212 stores a key frame map including a plurality of key frames that is based on a plurality of reference images imaged at different positions while the map generating vehicle travels.

Note that the number of the map generating vehicles used for generating the key frame map need not necessarily be one, and may be two or more.

Also, the key frame map DB 212 need not necessarily be provided in the vehicle 10, and may be provided in a server, for example. In this case, for example, the vehicle 10 refers to or downloads the key frame map stored in the key frame map DB 212 before or during travel.

The self-localization processing unit 213 is provided in the vehicle 10 and performs self-localization processing of the vehicle 10. The self-localization processing unit 213 includes an image acquisition unit 231, a feature point detection unit 232, a comparison unit 233, a self-localization unit 234, a movable area detection unit 235, and a movement control unit 236.

The image acquisition unit 231 includes a camera, for example, to image an area in front of the vehicle 10 and supply the captured image obtained (hereinafter referred to as a front image) to the feature point detection unit 232 and the movable area detection unit 235.

The feature point detection unit 232 performs processing of detecting a feature point in the front image, and supplies data indicating a result of the detection to the comparison unit 233.

The comparison unit 233 compares the front image with the key frame of the key frame map stored in the key frame map DB 212. More specifically, the comparison unit 233 performs feature point matching between the front image and the key frame. The comparison unit 233 supplies, to the self-localization unit 234, matching information obtained by performing the feature point matching and data indicating the position and orientation at which the key frame used for matching (hereinafter referred to as a reference key frame) is acquired.

The self-localization unit 234 estimates the position and orientation of the vehicle 10 on the basis of the matching information between the front image and the key frame, and the position and orientation at which the reference key frame is acquired. The self-localization unit 234 supplies data indicating a result of the estimation processing to the map analysis unit 151, the traffic rule recognition unit 152, the situation recognition unit 153, and the like of FIG. 1 and to the comparison unit 233 and the movement control unit 236.

The movable area detection unit 235 detects an area in which the vehicle 10 can move (hereinafter referred to as a movable area) on the basis of the front image, and supplies data indicating a result of the detection to the movement control unit 236.

The movement control unit 236 controls the movement of the vehicle 10. For example, the movement control unit 236 supplies, to the operation planning unit 163 of FIG. 1, instruction data that gives an instruction to cause the vehicle 10 to approach the position at which the key frame is acquired within the movable area, thereby causing the vehicle 10 to approach the position at which the key frame is acquired.

Note that in a case where the key frame generation unit 211 is provided in the vehicle 10 instead of the map generating vehicle, that is, in a case where the vehicle used for generating the key frame map is the same vehicle as that performing the self-localization processing, for example, the image acquisition unit 221 and the feature point detection unit 222 of the key frame generation unit 211 and the image acquisition unit 231 and the feature point detection unit 232 of the self-localization processing unit 213 can be shared.

<Key Frame Generation Processing>

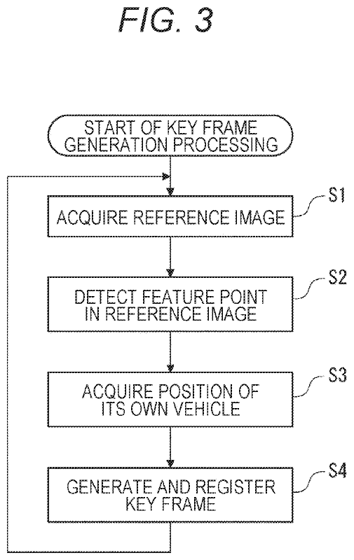

Next, the key frame generation processing executed by the key frame generation unit 211 will be described with reference to a flowchart of FIG. 3. Note that this processing is started when, for example, the map generating vehicle is started and an operation to start driving is performed such as when an ignition switch, a power switch, a start switch, or the like of the map generating vehicle is turned on. Moreover, this processing is ended when, for example, an operation to end driving is performed such as when the ignition switch, the power switch, the start switch, or the like of the map generating vehicle is turned off.

In step S1, the image acquisition unit 221 acquires a reference image. Specifically, the image acquisition unit 221 images an area in front of the map generating vehicle and supplies the acquired reference image to the feature point detection unit 222.

In step S2, the feature point detection unit 232 detects feature points in the reference image and supplies data indicating a result of the detection to the key frame registration unit 225.

Note that for the method of detecting the feature points, an arbitrary method such as Harris corner detection can be used, for example.

In step S3, the self position acquisition unit 223 acquires a position of its own vehicle. That is, the self position acquisition unit 223 uses an arbitrary method to acquire data indicating the position and orientation of the map generating vehicle in a map coordinate system, and supply the data to the key frame registration unit 225.

In step S4, the key frame registration unit 225 generates and registers a key frame. Specifically, the key frame registration unit 225 generates a key frame that contains data indicating the position and feature value of each feature point detected in the reference image in an image coordinate system, and the position and orientation of the map generating vehicle in the map coordinate system when the reference image is imaged (that is, the position and orientation at which the key frame is acquired). The key frame registration unit 225 registers the generated key frame in the key frame map DB 212.

The processing thereafter returns to step S1, and the processings in and after step S1 are executed.

Therefore, key frames are generated on the basis of the corresponding reference images imaged at different positions from the map generating vehicle in motion, and are registered in a key frame map.

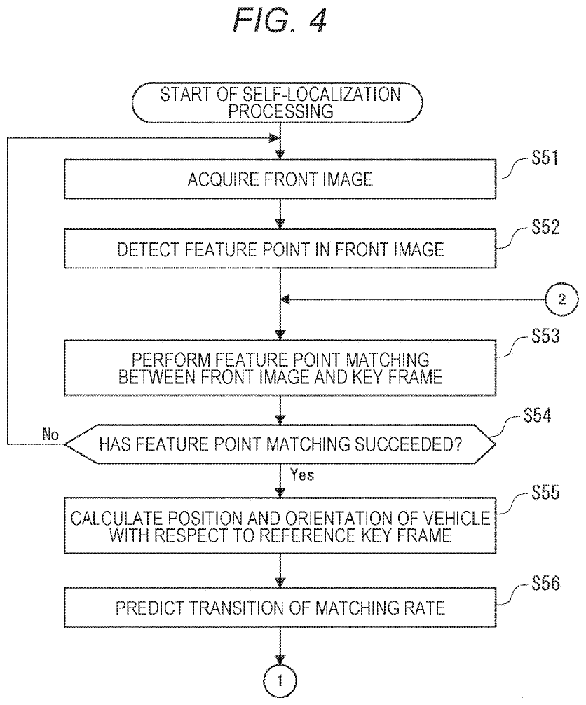

Next, the self-localization processing executed by the self-localization processing unit 213 will be described with reference to a flowchart of FIG. 4. Note that this processing is started when, for example, the vehicle 10 is started and an operation to start driving is performed such as when an ignition switch, a power switch, a start switch, or the like of the vehicle 10 is turned on. Moreover, this processing is ended when, for example, an operation to end driving is performed such as when the ignition switch, the power switch, the start switch, or the like of the vehicle 10 is turned off.

In step S51, the image acquisition unit 231 acquires a front image. Specifically, the image acquisition unit 231 images an area in front of the vehicle 10 and supplies the acquired front image to the feature point detection unit 232 and the movable area detection unit 235.

In step S52, the feature point detection unit 232 detects feature points in the front image. The feature point detection unit 232 supplies data indicating a result of the detection to the comparison unit 233.

Note that a method similar to that used by the feature point detection unit 222 of the key frame generation unit 211 is used for the method of detecting the feature points.

In step S53, the comparison unit 233 performs feature point matching between the front image and a key frame. For example, among the key frames stored in the key frame map DB 212, the comparison unit 233 searches for the key frame that is acquired at a position close to the position of the vehicle 10 at the time of imaging the front image. Next, the comparison unit 233 performs matching between the feature points in the front image and feature points in the key frame obtained by the search (that is, feature points in the reference image imaged in advance).

Note that in a case where a plurality of key frames is extracted, the feature point matching is performed between the front image and each of the key frames.

Next, in a case where the feature point matching has succeeded between the front image and a certain key frame, the comparison unit 233 calculates a matching rate between the front image and the key frame with which the feature point matching has succeeded. For example, the comparison unit 233 calculates, as the matching rate, a ratio of the feature points that have been successfully matched with the feature points in the key frame among the feature points in the front image. Note that in a case where the feature point matching has succeeded with a plurality of key frames, the matching rate is calculated for each of the key frames.

Then, the comparison unit 233 selects the key frame with the highest matching rate as a reference key frame. Note that in case where the feature point matching has succeeded with only one key frame, that key frame is selected as the reference key frame.

The comparison unit 233 supplies, to the self-localization unit 234, matching information between the front image and the reference key frame, and data indicating the position and orientation at which the reference key frame is acquired. Note that the matching information includes, for example, the positions, correspondences, and the like of the feature points that have been successfully matched between the front image and the reference key frame.

In step S54, the comparison unit 233 determines whether or not the feature point matching has succeeded on the basis of a result of the processing in step S53. In a case where it is determined that feature point matching has failed, the processing returns to step S51.

After that, the processing from step S51 to step S54 is repeatedly executed until it is determined in step S54 that the feature point matching has succeeded.

Meanwhile, in a case where it is determined in step S54 that the feature point matching has succeeded, the processing proceeds to step S55.

In step S55, the self-localization unit 234 calculates the position and orientation of the vehicle 10 with respect to the reference key frame. Specifically, the self-localization unit 234 calculates the position and orientation of the vehicle 10 with respect to the position and orientation at which the reference key frame is acquired, on the basis of the matching information between the front image and the reference key frame as well as the position and orientation at which the reference key frame is acquired. More precisely, the self-localization unit 234 calculates the position and orientation of the vehicle 10 with respect to the position and orientation of the map generating vehicle when the reference image corresponding to the reference key frame is imaged. The self-localization unit 234 supplies data indicating the position and orientation of the vehicle 10 to the comparison unit 233 and the movement control unit 236.

Note that an arbitrary method can be used as the method of calculating the position and orientation of the vehicle 10.

In step S56, the comparison unit 233 predicts a transition of the matching rate.

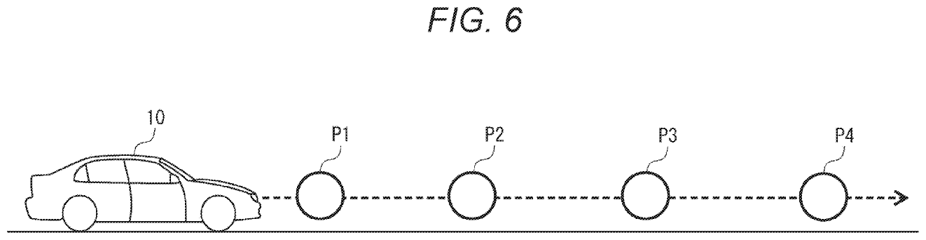

Here, an example of a method of predicting the transition of the matching rate will be described with reference to FIGS. 6 to 8.

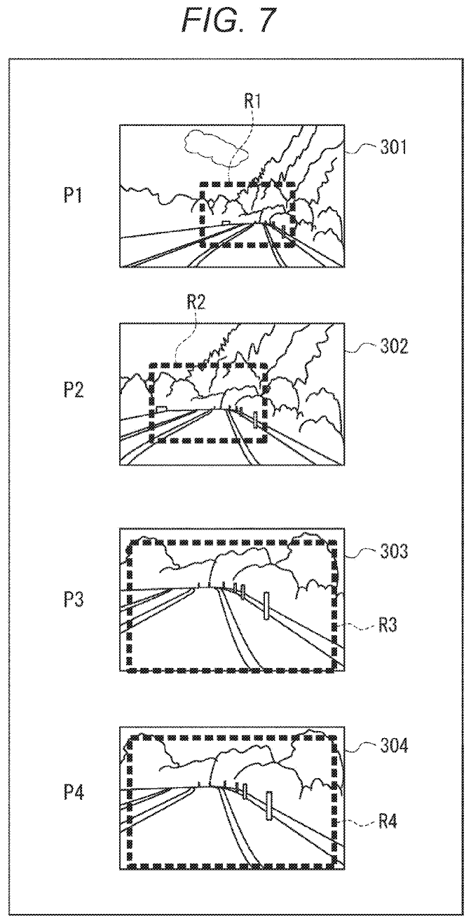

FIG. 7 illustrates an example of a front image that is imaged at positions P1 to P4 in a case where the vehicle 10 moves (forward) as illustrated in FIG. 6. Specifically, front images 301 to 304 are front images imaged by the image acquisition unit 231 when the vehicle 10 is at the positions P1 to P4, respectively. Note that the position P3 is assumed to be the same position as the position at which the reference key frame is acquired.

More specifically, for example, the front image 301 is imaged while the vehicle 10 travels ten meters behind the position at which the reference key frame is acquired, and is turned ten degrees counterclockwise with respect to the orientation at which the reference key frame is acquired. A dotted region R1 in the front image 301 is a region having a high matching rate with the reference key frame. For example, the matching rate between the front image 301 and the reference key frame is about 51%.

The front image 302 is imaged while the vehicle 10 travels five meters behind the position at which the reference key frame is acquired, and is turned five degrees counterclockwise with respect to the orientation at which the reference key frame is acquired. A dotted region R2 in the front image 302 is a region having a high matching rate with the reference key frame. For example, the matching rate between the front image 302 and the reference key frame is about 75%.

The front image 303 is imaged while the vehicle 10 is at the same position and orientation as the position and orientation at which the reference key frame is acquired. A dotted region R3 in the front image 303 is a region having a high matching rate with the reference key frame. For example, the matching rate between the front image 303 and the reference key frame is about 93%.

The front image 304 is imaged while the vehicle 10 travels five meters ahead of the position at which the reference key frame is acquired, and is turned two degrees counterclockwise with respect to the orientation at which the reference key frame is acquired. A dotted region R4 in the front image 304 is a region having a high matching rate with the reference key frame. For example, the matching rate between the front image 304 and the reference key frame is about 60%.

Thus, the matching rate usually increases as the vehicle 10 approaches the position at which the reference key frame is acquired, and decreases after the vehicle passes the position at which the reference key frame is acquired.

Therefore, the comparison unit 233 assumes that the matching rate increases linearly as a relative distance between the position at which the reference key frame is acquired and the vehicle 10 decreases, and the matching rate equals 100% when the relative distance is equal to zero meter. Then, under the assumption, the comparison unit 233 derives a linear function (hereinafter referred to as a matching rate prediction function) for predicting the transition of the matching rate.

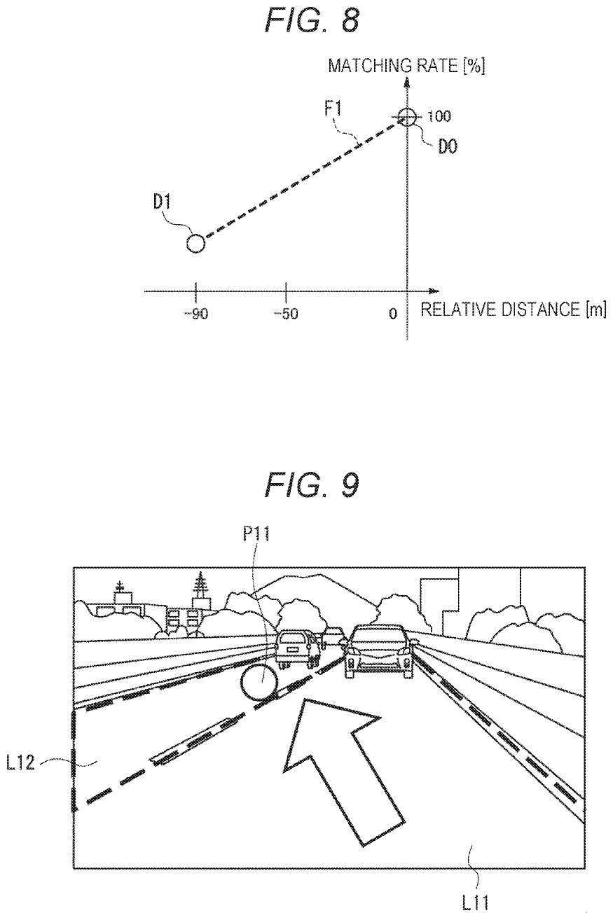

For example, FIG. 8 illustrates an example of the matching rate prediction function. The horizontal axis in FIG. 8 indicates the relative distance between the position at which the reference key frame is acquired and the vehicle 10. Note that a side behind the position at which the reference key frame is acquired corresponds to a negative direction, and a side ahead of the position at which the reference key frame is acquired corresponds to a positive direction. Accordingly, the relative distance takes a negative value until the vehicle 10 reaches the position at which the reference key frame is acquired, and takes a positive value after the vehicle 10 passes the position at which the reference key frame is acquired. Moreover, the vertical axis in FIG. 7 indicates the matching rate.

A point D0 is a point where the relative distance=0 m and the matching rate=100%. A point D1 is a point corresponding to the relative distance and the matching rate when the feature point matching is first successful. For example, the comparison unit 233 derives a matching rate prediction function F1 represented by a straight line passing through the points D0 and D1.

In step S57, the self-localization processing unit 213 detects a movable area. For example, the movable area detection unit 235 detects a lane marker such as a white line on the road surface within the front image. Next, on the basis of a result of the detection of the lane marker, the movable area detection unit 235 detects a driving lane in which the vehicle 10 is traveling, a parallel lane allowing travel in the same direction as the driving lane, and an oncoming lane allowing travel in a direction opposite to that of the driving lane. Then, the movable area detection unit 235 detects the driving lane and the parallel lane as the movable area, and supplies data indicating a result of the detection to the movement control unit 236.

In step S58, the movement control unit 236 determines whether or not to make a lane change. Specifically, in a case where there are two or more lanes allowing travel in the same direction as the vehicle 10, the movement control unit 236 estimates a lane in which the reference key frame is acquired (hereinafter referred to as a key frame acquisition lane) on the basis of a result of estimation of the position and orientation of the vehicle 10 with respect to the position and orientation at which the reference key frame is acquired. That is, the key frame acquisition lane is a lane in which the map generating vehicle is estimated to be traveling when the reference image corresponding to the reference key frame is imaged. The movement control unit 236 determines to make a lane change in a case where the estimated key frame acquisition lane is different from the current driving lane of the vehicle 10 and a lane change to the key frame acquisition lane can be executed safely, whereby the processing proceeds to step S59.

In step S59, the movement control unit 236 instructs a lane change. Specifically, the movement control unit 236 supplies instruction data indicating an instruction to change the lane to the key frame acquisition lane to, for example, the operation planning unit 163 in FIG. 1. As a result, the driving lane of the vehicle 10 is changed to the key frame acquisition lane.

For example, FIG. 9 illustrates an example of a front image that is imaged from the vehicle 10. Here, it is assumed that the vehicle 10 is traveling in a lane L11, and a position P11 at which the reference key frame is acquired is in a lane L12 to the left. Thus, the lane L12 is the key frame acquisition lane.

In this example, the lane in which the vehicle 10 travels is changed from the lane L11 to the lane L12. Therefore, the vehicle 10 can travel a position closer to the position P11 at which the reference key frame is acquired, and the matching rate between the front image and the reference key frame is improved as a result.

The processing thereafter proceeds to step S60.

On the other hand, in step S58, the movement control unit 236 determines to not make a lane change in a case where, for example, there is one lane allowing travel in the same direction as the vehicle 10, the vehicle 10 is traveling in the key frame acquisition lane, a lane change to the key frame acquisition lane cannot be executed safely, or the estimation of the key frame acquisition lane has failed. Thus, the processing of step S59 is skipped, and the processing proceeds to step S60.

In step S60, a front image is acquired as with the processing in step S51.

In step S61, feature points in the front image are detected as with the processing in step S52.

In step S62, the comparison unit 233 performs feature point matching without changing the reference key frame. That is, the comparison unit 233 performs the feature point matching between the front image newly acquired in the processing of step S60 and the reference key frame selected in the processing of step S53. Moreover, in a case where the feature point matching has succeeded, the comparison unit 233 calculates a matching rate and supplies matching information as well as data indicating the position and orientation at which the reference key frame is acquired to the self-localization unit 234.

In step S63, the comparison unit 233 determines whether or not the feature point matching has succeeded on the basis of a result of the processing in step S62. In a case where it is determined that the feature point matching has succeeded, the processing proceeds to step S64.

In step S64, the position and orientation of the vehicle 10 with respect to the reference key frame are calculated as with the processing in step S55.

In step S65, the comparison unit 233 determines whether or not an amount of error of the matching rate is greater than or equal to a predetermined threshold.

Specifically, the comparison unit 233 calculates a predicted value of the matching rate by substituting the relative distance of the vehicle 10 with respect to the position at which the reference key frame is acquired into the matching rate prediction function. Then, the comparison unit 233 calculates, as the amount of error of the matching rate, a difference between the actual matching rate calculated in the processing of step S62 (hereinafter referred to as a calculated value of the matching rate) and the predicted value of the matching rate.

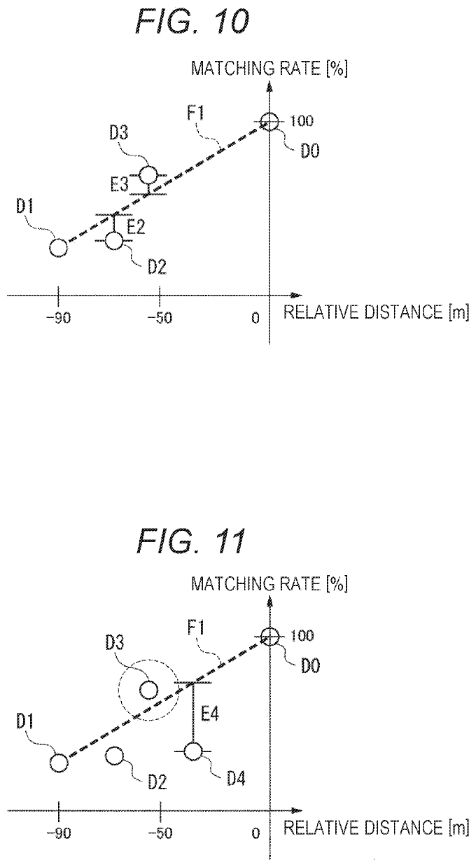

For example, points D2 and D3 in FIG. 10 indicate calculated values of the matching rate. Then, a predicted value of the matching rate is calculated by substituting a relative distance corresponding to the point D2 into the matching rate prediction function F1, and a difference between the calculated value and the predicted value of the matching rate is calculated as an amount of error E2. Similarly, a predicted value of the matching rate is calculated by substituting a relative distance corresponding to the point D3 into the matching rate prediction function F1, and a difference between the calculated value and the predicted value of the matching rate is calculated as an amount of error E3.

Then, in a case where the comparison unit 233 determines that the amount of error of the matching rate is less than the predetermined threshold, the processing returns to step S57.

After that, the processing from step S57 to step S65 is repeatedly executed until it is determined in step S63 that the feature point matching has failed, or it is determined in step S65 that the amount of error of the matching rate is greater than or equal to the predetermined threshold.

On the other hand, in a case where it is determined in step 65 that the amount of error of the matching rate is greater than or equal to the predetermined threshold, the processing proceeds to step S66.

For example, a point D4 in FIG. 11 indicates a calculated value of the matching rate. Then, a predicted value of the matching rate is calculated by substituting a relative distance corresponding to the point D4 into the matching rate prediction function F1, and a difference between the calculated value and the predicted value of the matching rate is calculated as an amount of error E4. Then, in a case where it is determined that the amount of error E4 is greater than or equal to the threshold, the processing proceeds to step S66.

For example, the amount of error of the matching rate is expected to be greater than or equal to the threshold in a case where the vehicle 10 passes the position at which the reference key frame is acquired, the vehicle 10 moves away from the position at which the reference key frame is acquired, the vehicle 10 changes the direction of travel, or the like.

Moreover, in a case where it is determined in step S63 that the feature point matching has failed, the processings in steps S64 and S65 are skipped, and the processing proceeds to step S66.

This corresponds to a case where the feature point matching has succeeded up to the front image of a previous frame, and has failed in the front image of a current frame. This is expected to occur in a case where, for example, the vehicle 10 passes the position at which the reference key frame is acquired, the vehicle 10 moves away from the position at which the reference key frame is acquired, the vehicle 10 changes the direction of travel, or the like.

In step S66, the self-localization unit 234 finalizes a result of the estimation of the position and orientation of the vehicle 10. That is, the self-localization unit 234 performs final self-localization of the vehicle 10.

For example, on the basis of the matching rate, the self-localization unit 234 selects a front image (hereinafter referred to as a selected image) to be used for the final self-localization of the vehicle 10 from among the front images that have been subjected to the feature point matching with the current reference key frame.

For example, the front image with the maximum matching rate is selected as the selected image. In other words, the front image having the highest degree of similarity with the reference image corresponding to the reference key frame is selected as the selected image. For example, in the example of FIG. 11, the front image corresponding to the point D3 with the maximum matching rate is selected as the selected image.

Alternatively, for example, one of the front images whose amount of error of the matching rate is less than a threshold is selected as the selected image. For example, in the example of FIG. 11, one of the front images corresponding to the points D1 to D3 at which the amount of error of the matching rate is less than the threshold is selected as the selected image.

Alternatively, for example, in a case where the matching rates are arranged in the order in which the front images are imaged, the front image immediately before one with a decrease in the matching rate is selected as the selected image. For example, in the example of FIG. 11, the front image corresponding to the point D3 immediately before the point D4 at which the matching rate decreases is selected as the selected image.

Next, the self-localization unit 234 converts the position and orientation of the vehicle 10 with respect to the position and orientation at which the reference key frame is acquired into position and orientation in a map coordinate system, the position and orientation of the vehicle 10 being calculated on the basis of the selected image. The self-localization unit 234 then supplies data indicating a result of the estimation of the position and orientation of the vehicle 10 in the map coordinate system to, for example, the map analysis unit 151, the traffic rule recognition unit 152, the situation recognition unit 153, and the like of FIG. 1.

The processing thereafter returns to step S53, and the processings in and after step S53 are executed. Thus, the position and orientation of the vehicle 10 are estimated on the basis of a new reference key frame.

As described above, the feature point matching is performed between the plurality of front images and the reference key frame, the selected image is selected on the basis of the matching rate, and the position and orientation of the vehicle 10 are estimated on the basis of the selected image. Therefore, self-localization of the vehicle 10 is performed using a more appropriate front image so that the estimation accuracy is improved.

Moreover, the matching rate between the front image and the reference key frame is improved by changing the driving lane of the vehicle 10 to the key frame acquisition lane, and as a result, the accuracy of self-localization of the vehicle 10 is improved.

### 3. Variation

Hereinafter, a variation of the aforementioned embodiment of the present technology will be described.

The present technology can be applied to a case where self-localization processing is performed using not only the image obtained by imaging the area in front of the vehicle 10 but an image (hereinafter referred to as a surrounding image) obtained by imaging an arbitrary direction around the vehicle 10 (for example, the side, rear, or the like). The present technology can also be applied to a case where self-localization processing is performed using a plurality of surrounding images obtained by imaging a plurality of different directions from the vehicle 10.

Moreover, although the above description has illustrated the example in which the position and orientation of the vehicle 10 are estimated, the present technology can also be applied to a case where only one of the position and orientation of the vehicle 10 is estimated.

Furthermore, the present technology can also be applied to a case where a surrounding image and a reference image are compared by a method other than feature point matching, and self-localization is performed on the basis of a result of the comparison. In this case, for example, self-localization is performed on the basis of a result of comparing the reference image with the surrounding image having the highest degree of similarity to the reference image.

Moreover, although the above description has illustrated the example in which the lane change allows the vehicle 10 to approach the position at which the key frame is acquired, a method other than the lane change may be used to allow the vehicle 10 to approach the position at which the key frame is acquired. For example, the vehicle 10 may be moved within the same lane to pass through a position as close as possible to the position at which the key frame is acquired.

Moreover, the present technology can also be applied to a case where self-localization of various mobile bodies in addition to the vehicle exemplified above is performed, the various mobile bodies including a motorcycle, a bicycle, personal mobility, an airplane, a ship, construction machinery, agricultural machinery (a tractor), and the like. Furthermore, the mobile body to which the present technology can be applied also includes, for example, a mobile body such as a drone or a robot that is driven (operated) remotely by a user without boarding it.

### 4. Other

<Example of Configuration of Computer>

The series of processings described above can be executed by hardware or software. In a case where the series of processings is executed by software, a program configuring the software is installed on a computer. Here, the computer includes a computer incorporated in dedicated hardware, a general-purpose personal computer or the like that can execute various functions by installing various programs, or the like.

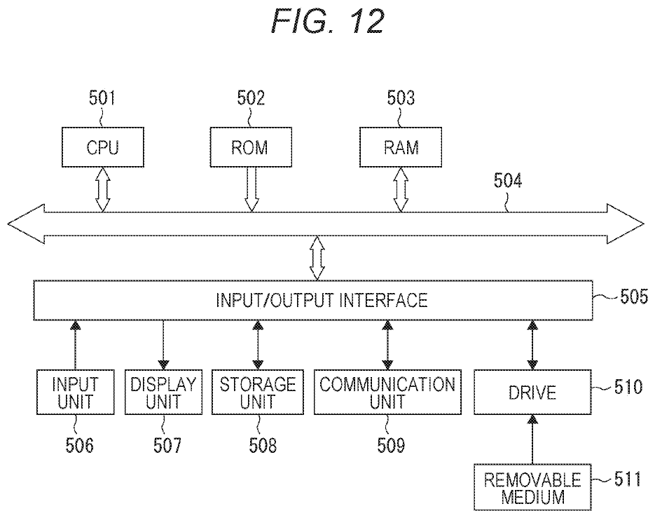

FIG. 12 is a block diagram illustrating an example of the configuration of hardware of a computer that executes the series of processings described above according to a program.

In a computer 500, a Central Processing Unit (CPU) 501, a Read Only Memory (ROM) 502, and a Random Access Memory (RAM) 503 are mutually connected via a bus 504.

An input/output interface 505 is also connected to the bus 504. The input/output interface 505 is connected to an input unit 506, an output unit 507, a recording unit 508, a communication unit 509, and a drive 510.

The input unit 506 includes an input switch, a button, a microphone, an image sensor, or the like. The output unit 507 includes a display, a speaker, or the like. The recording unit 508 includes a hard disk, a non-volatile memory, or the like. The communication unit 509 includes a network interface or the like. The drive 510 drives a removable recording medium 511 such as a magnetic disk, an optical disk, a magneto-optical disk, or a semiconductor memory.

In the computer 500 configured as described above, the series of processings described above is performed by, for example, the CPU 501 loading the program recorded in the recording unit 508 to the RAM 503 via the input/output interface 505 and the bus 504, and executing the program.

The program executed by the computer 500 (CPU 501) can be provided while recorded in the removable recording medium 511 as a package medium or the like, for example. The program can also be provided via a wired or wireless transmission medium such as a local area network, the Internet, or digital satellite broadcasting.

In the computer 500, the program can be installed in the recording unit 508 via the input/output interface 505 by placing the removable recording medium 511 in the drive 510. Also, the program can be received by the communication unit 509 via the wired or wireless transmission medium and installed in the recording unit 508. In addition, the program can be installed in advance in the ROM 502 or the recording unit 508.

Note that the program executed by the computer may be a program by which the processing is executed chronologically according to the order described in the present specification, or may be a program by which the processing is executed in parallel or at a required timing such as when a call is made.

Moreover, in the present specification, the system refers to the assembly of a plurality of components (such as devices and modules (parts)), where it does not matter whether or not all the components are housed in the same housing. Accordingly, a plurality of devices housed in separate housings and connected through a network as well as a single device with a plurality of modules housed in a single housing are both a system.

Furthermore, the embodiment of the present technology is not limited to the above-described embodiment but can be modified in various ways without departing from the scope of the present technology.

For example, the present technology can adopt the configuration of cloud computing in which a single function is shared and processed collaboratively among a plurality of devices through a network.

Moreover, each step described in the aforementioned flowcharts can be executed by a single device or can be shared and executed by a plurality of devices.

Furthermore, in a case where a single step includes a plurality of processings, the plurality of processings included in the single step can be executed by a single device or can be shared and executed by a plurality of devices.

<Examples of Combination of Configurations>

The present technology can also have the following configurations.

(1)

An information processing apparatus including:

a comparison unit that compares a plurality of captured images with a reference image imaged in advance, the plurality of captured images being images obtained by imaging a predetermined direction at different positions; and

a self-localization unit that performs self-localization of a mobile body on the basis of a result of the comparison between each of the plurality of captured images and the reference image.

(2)

The information processing apparatus according to (1), further including:

a feature point detection unit that detects a feature point in the plurality of captured images, in which

the comparison unit performs feature point matching between each of the plurality of captured images and the reference image, and

the self-localization unit performs self-localization of the mobile body on the basis of matching information obtained by the feature point matching.

(3)

The information processing apparatus according to (2), in which

the comparison unit calculates a matching rate of the feature point between each of the plurality of captured images and the reference image, and

the self-localization unit performs self-localization of the mobile body on the basis of also the matching rate.

(4)

The information processing apparatus according to (3), in which

the self-localization unit selects the captured image to be used for self-localization of the mobile body on the basis of the matching rate, and performs self-localization of the mobile body on the basis of the matching information between the captured image selected and the reference image.

(5)

The information processing apparatus according to (4), in which

the self-localization unit selects the captured image, the matching rate of which with the reference image is a highest, as the captured image to be used for self-localization of the mobile body.

(6)

The information processing apparatus according to (4), in which

the comparison unit predicts a transition of the matching rate, and

the self-localization unit selects the captured image to be used for self-localization of the mobile body from among the captured images in which a difference between a predicted value of the matching rate and an actual value of the matching rate is less than a predetermined threshold.

(7)

The information processing apparatus according to any one of (1) to (6), in which

the self-localization unit performs self-localization of the mobile body on the basis of a position and an orientation at which the reference image is imaged.

(8)

The information processing apparatus according to (7), further including:

a movable area detection unit that detects a movable area in which the mobile body can move on the basis of the captured images; and

a movement control unit that controls a movement of the mobile body to allow the mobile body to approach a position at which the reference image is imaged within the movable area.

(9)

The information processing apparatus according to (8), in which

the mobile body is a vehicle, and

the movement control unit controls a movement of the mobile body to cause the mobile body to travel in a lane in which the reference image is imaged.

(10)

The information processing apparatus according to any one of (7) to (9), in which

the self-localization unit estimates at least one of a position or an orientation of the mobile body.

(11)

The information processing apparatus according to (1), in which

the self-localization unit performs self-localization of the mobile body on the basis of a result of comparison between the reference image and the captured image having a highest degree of similarity with the reference image.

(12)

A self-localization method of an information processing apparatus, in which

the information processing apparatus performs:

comparison between a plurality of captured images and a reference image imaged in advance, the plurality of captured images being images obtained by imaging a predetermined direction at different positions; and

self-localization of a mobile body on the basis of a result of the comparison between each of the plurality of captured images and the reference image.

(13)

A program that causes a computer to execute processing of:

comparison between a plurality of captured images and a reference image imaged in advance, the plurality of captured images being images obtained by imaging a predetermined direction at different positions; and

self-localization of a mobile body on the basis of a result of the comparison between each of the plurality of captured images and the reference image.

(14)

A mobile body including:

a comparison unit that compares a plurality of captured images with a reference image imaged in advance, the plurality of captured images being images obtained by imaging a predetermined direction at different positions; and

a self-localization unit that performs self-localization on the basis of a result of the comparison between each of the plurality of captured images and the reference image.

Note that the effect described in the present specification is provided by way of example and not by way of limitation, where there may be another effect.

### REFERENCE SIGNS LIST

10 Vehicle
100 Vehicle control system
132 Self-localization unit
135 Operation control unit
141 Extra-vehicle information detecting unit
153 Situation recognition unit
162 Action planning unit
163 Operation planning unit
201 Self-localization system
211 Key frame generation unit
212 Key frame map DB
213 Self-localization processing unit
231 Image acquisition unit
232 Feature point detection unit
233 Comparison unit
234 Self-localization unit
235 Movable area detection unit
236 Movement control unit

1. An information processing apparatus comprising:
a comparison unit that compares a plurality of captured images with a reference image imaged in advance, the plurality of captured images being images obtained by imaging a predetermined direction at different positions; and
a self-localization unit that performs self-localization of a mobile body on a basis of a result of the comparison between each of the plurality of captured images and the reference image.

2. The information processing apparatus according to claim 1, further comprising:
a feature point detection unit that detects a feature point in the plurality of captured images, wherein
the comparison unit performs feature point matching between each of the plurality of captured images and the reference image, and
the self-localization unit performs self-localization of the mobile body on a basis of matching information obtained by the feature point matching.

3. The information processing apparatus according to claim 2, wherein
the comparison unit calculates a matching rate of the feature point between each of the plurality of captured images and the reference image, and
the self-localization unit performs self-localization of the mobile body on a basis of also the matching rate.

4. The information processing apparatus according to claim 3, wherein
the self-localization unit selects the captured image to be used for self-localization of the mobile body on a basis of the matching rate, and performs self-localization of the mobile body on a basis of the matching information between the captured image selected and the reference image.

5. The information processing apparatus according to claim 4, wherein
the self-localization unit selects the captured image, the matching rate of which with the reference image is a highest, as the captured image to be used for self-localization of the mobile body.

6. The information processing apparatus according to claim 4, wherein
the comparison unit predicts a transition of the matching rate, and
the self-localization unit selects the captured image to be used for self-localization of the mobile body from among the captured images in which a difference between a predicted value of the matching rate and an actual value of the matching rate is less than a predetermined threshold.

7. The information processing apparatus according to claim 1, wherein
the self-localization unit performs self-localization of the mobile body on a basis of a position and an orientation at which the reference image is imaged.

8. The information processing apparatus according to claim 7, further comprising:
a movable area detection unit that detects a movable area in which the mobile body can move on a basis of the captured images; and
a movement control unit that controls a movement of the mobile body to allow the mobile body to approach a position at which the reference image is imaged within the movable area.

9. The information processing apparatus according to claim 8, wherein
the mobile body is a vehicle, and
the movement control unit controls a movement of the mobile body to cause the mobile body to travel in a lane in which the reference image is imaged.

10. The information processing apparatus according to claim 7, wherein
the self-localization unit estimates at least one of a position or an orientation of the mobile body.

11. The information processing apparatus according to claim 1, wherein
the self-localization unit performs self-localization of the mobile body on a basis of a result of comparison between the reference image and the captured image having a highest degree of similarity with the reference image.

12. A self-localization method of an information processing apparatus, wherein
the information processing apparatus performs:
comparison between a plurality of captured images and a reference image imaged in advance, the plurality of captured images being images obtained by imaging a predetermined direction at different positions; and
self-localization of a mobile body on a basis of a result of the comparison between each of the plurality of captured images and the reference image.

13. A program that causes a computer to execute processing of:
comparison between a plurality of captured images and a reference image imaged in advance, the plurality of captured images being images obtained by imaging a predetermined direction at different positions; and
self-localization of a mobile body on a basis of a result of the comparison between each of the plurality of captured images and the reference image.

14. A mobile body comprising:
a comparison unit that compares a plurality of captured images with a reference image imaged in advance, the plurality of captured images being images obtained by imaging a predetermined direction at different positions; and
a self-localization unit that performs self-localization on a basis of a result of the comparison between each of the plurality of captured images and the reference image.
